(19) United States
(12) Patent Application Publication
(10) Pub. No.: US 2007/0116896 A1
(43) Pub. Date: May 24, 2007

(54) Method for manufacturing front scattering film having no wavelength dependency

(75) Inventors: Sergiy Shylo, Suwon-si (KR); Chang Hwan Choi, Seongnam-si (KR); Ju Ho Kim, Seoul (KR); Mi Jeong Yun, Jung-gu (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/602,951

(22) Filed: Nov. 22, 2006

(30) Foreign Application Priority Data
Nov. 23, 2005 (KR) 10-2005-0112380
Nov. 6, 2006 (KR) 10-2006-0108919

(51) Int. Cl. C09K 19/00

(52) U.S. Cl. 428/1.1; 523/223

(57) ABSTRACT

Disclosed herein is a method for manufacturing a front scattering film that provides uniform scattering characteristics for lights emitted from light sources having different wavelengths. The front scattering film is used for backlight units, includes an optically transparent binder having a plurality of spherical dielectric particles dispersed therein, receives lights from at least two light sources having different wavelengths, and reflects white light. The method includes the steps of determining the optically transparent binder, the refractive index of the spherical dielectric particles, and the sizes and concentrations of the spherical dielectric particles in the optically transparent binder. The determination steps are carried out by comparing scattering characteristics, which are calculated using a numerical analysis method based on Mie theory. The scattering characteristics in the frontward direction are significantly greater than the scattering characteristics in the backward direction. Thus, a front scattering film can be provided which can reflect uniform white light effectively corresponding to a backlight unit system including a plurality of light sources having different wavelengths.

### CROSS REFERENCE TO RELATED APPLICATION(S)

This application claims the benefit of Korean Patent Application No. 10-2005-0112380, filed Nov. 23, 2005, entitled “Front scattering film without wavelength-dependency”, and Korean Patent Application No. 10-2006-0108919, filed Nov. 6, 2006, entitled “Manufacturing method of front scattering film without wavelength-dependency”, which are hereby incorporated by reference in its entirety into this application.

### BACKGROUND OF THE INVENTION

1. Field of the Invention

The present invention relates to a method for manufacturing a front scattering film, and more particularly to a front scattering film that provides uniform scattering characteristics for lights emitted from at least two light sources having different wavelengths, as well as a manufacturing method thereof.

2. Description of the Prior Art

Recently, technology pertaining to backlight unit (BLU) systems has spread worldwide. The notable success of liquid crystal display (LCD) devices has spurred the development of backlight (transmission) type displays that are coupled with these devices. Generally, the LCD display device LCD comprises a light emitting diode (LED) array disposed behind a screen. To increase the image uniformity of the screen, some additional components are used.

Such additional components include a light scattering film to which the present invention relates.

The light-scattering (or diffusing) film is incorporated in order to obtain uniform luminance characteristics by diff-using light from the LED array. In general, the light scattering film consists of a polymer binder and organic or inorganic microparticles dispersed therein.

One example of the light-scattering film is disclosed in U.S. Pat. No. 6,517,914 B1. FIG. 1 shows an anisotropic light-scattering film disclosed in said US patent publication, and the light-scattering film according to this prior art will now be described with reference to FIG. 1.

Referring to FIG. 1, an anisotropic light-scattering film 1 according to the prior art consists of a continuous film comprising a plurality of dispersed phase particles 2, and has light scattering characteristics that differ between the x-axis and y-axis directions with respect to the surface of the film.

For example, the film satisfies a range of Fy(θ)/Fx(θ)>5, wherein Fx(θ) represents the scattering characteristic in the direction of the x-axis, and Fy(θ) represents the scattering characteristic in the direction of the Y-axis. The prior light-scattering film assures a uniform surface emission by applying anisotropic particles dispersed in transparent resin for light from a single light source.

U.S. Pat. No. 6,654,085 B1 discloses a front scattering film capable of reducing backward scattering and providing a clear display. The front scattering film comprises a light-scattering layer composed of a transparent polymer binder and spherical microparticles dispersed in the binder. This prior front scattering film is characterized in that it reduces backward scattering through the action of microparticles having a refractive index different from the binder and provides a clear display. Also, the refractive ratio between the binder and the particles is defined as 0.91<n_{particle}/n_{binder}<0.99, wherein n_{particle} represents the refractive index of the microparticles, and n_{binder} represents the refractive index of the binder.

As described above, the prior light-scattering films generally relate to structures and refractive index ratios, which allow light (e.g., single white light) from a single light source to be scattered uniformly in front of a screen. These films are difficult to apply to a backlight unit system by mixing lights from a plurality of light sources, which is a recently used technique.

In other words, the light-scattering films have a structure that scatters and reflects single-wavelength light, and thus, if the prior films are applied to lights emitted from three-color light sources having, for example, red, green and blue, they will show different scattering characteristics for the different sources of light. For this reason, in a three-color light source system that produces white light by mixing three colors, it is difficult to produce uniform white light from three-color light sources.

### SUMMARY OF THE INVENTION

It is an object of the present invention to provide a light-scattering film for application in a backlight unit system that produces uniform white light by mixing lights coming out from at least two light sources having different wavelengths, as well as a manufacturing method thereof.

Another object of the present invention is to provide a front scattering film that reduces backward scattering characteristics and, at the same time, provides optimized scattering characteristics for at least two light sources having different wavelengths, as well as a manufacturing method thereof.

To achieve the above objects, according to one aspect of the present invention, there is provided a method for manufacturing a scattering film for backlight units, which comprises an optically transparent binder having a plurality of spherical dielectric particles dispersed therein, receives lights from at least two light sources having different wavelengths and reflects white light, the method comprising the steps of: (a) determining an optically transparent binder; (b) determining the refractive indexes of a plurality of spherical dielectric particles on the basis of said at least two light sources and the determined optically transparent binder; and (c) determining the sizes of the spherical dielectric particles and the concentration ratio between the spherical dielectric particles on the basis of the light sources, the determined optically transparent binder and the determined refractive indexes of the spherical dielectric particles; wherein each of the steps (a) to (c) is carried out based on scattering characteristics expressed as scattering intensity (I) and scattering efficiency (Q), which are calculated using a numerical analysis method based on Mie theory, the scattering characteristics in the front direction with respect to the direction of light incident to the scattering film are significantly greater than the scattering characteristics in the backward direction, and the scattering characteristics for lights from said at least two light sources having different wavelengths are maintained uniform.

For reference, the Mie theory was used in the present invention to specify scattering characteristics, and the details of the used Mie theory can be found in the paper of Akihiro Tagaya et al., “Thin liquid-crystal display backlight system with highly scattering optical transmission polymers”, APPLIED OPTICS, Vol. 40, No. 34, Dec. 1, 2001.

In the present invention, the scattering characteristics are defined as scattering intensity, represented by Equation 1, and scattering efficiency (Q), represented by Equation 2:

$$\begin{matrix}I ( α , m , θ ) = \frac{{λ}^{2} ( {i}_{1} + {i}_{2} )}{8 {π}^{2}} & [ Equation 1 ] \\ Q ( α , m ) = \frac{{λ}^{2}}{2 {π}^{2} {r}^{2}} \cdot {\sum }_{v = 1}^{α} ( 2 v + 1 ) ( {\vert {a}_{v} \vert}^{2} + {\vert {b}_{v} \vert}^{2} ) & [ Equation 2 ]\end{matrix}$$

wherein α is a size parameter represented by Equation 3:

$$α = \frac{2 \cdot π \cdot r \cdot {n}_{m}}{{λ}_{0}} \qquad [ Equation 3 ]$$

wherein r is the radius of spherical dielectric particles, λ is the wavelength of light, m is the ratio between the refractive index (nₛ) of the spherical dielectric particles and (nₛ) and the refractive index (nₘ) of the matrix-type optically transparent binder (nₘ), each of i₁ and i₂ is represented by Equation 4, and each of a_{υ} and b_{υ} is represented by Equation 5:

$$\begin{matrix}{i}_{1} = {\vert {\sum }_{v = 1}^{∞} \frac{( 2 v + 1 )}{v ( v + 1 )} \cdot [ \begin{matrix}{a}_{v} \cdot \frac{{P}_{v}^{1} ( cos ( θ ) )}{sin ( θ )} + \\ {b}_{v} \cdot \frac{ⅆ {P}_{v}^{1} ( cos ( θ ) )}{ⅆ θ}\end{matrix} ] \vert}^{2} \\ {i}_{2} = {\vert {\sum }_{v = 1}^{∞} \frac{( 2 v + 1 )}{v ( v + 1 )} \cdot [ \begin{matrix}{b}_{v} \cdot \frac{{P}_{v}^{1} ( cos ( θ ) )}{sin ( θ )} + \\ {a}_{v} \cdot \frac{ⅆ {P}_{v}^{1} ( cos ( θ ) )}{ⅆ θ}\end{matrix} ] \vert}^{2} & [ Equation 4 ] \\ {a}_{v} = \frac{{ψ}_{v}^{′} ( m α ) \cdot {ψ}_{v} ( α ) - m {ψ}_{v} ( m α ) \cdot {ψ}_{v}^{′} ( α )}{{ψ}_{v}^{′} ( m α ) \cdot {}_{v} ( α ) - m {ψ}_{v} ( m α ) \cdot {}_{v}^{′} ( α )} \\ {b}_{v} = \frac{m \cdot {ψ}_{v}^{′} ( m α ) \cdot {ψ}_{v} ( α ) - {ψ}_{v} ( m α ) \cdot {ψ}_{v}^{′} ( α )}{m \cdot {ψ}_{v}^{′} ( m α ) \cdot {}_{v} ( α ) - {ψ}_{v} ( m α ) \cdot {}_{v}^{′} ( α )} & [ Equation 5 ]\end{matrix}$$

wherein ψ and ζ are the Riccarti-Bessel functions.

In the present invention, the step (a) preferably comprises the sub-steps of: (a-1) calculating scattering characteristics for each of the cases where a plurality of spherical dielectric particles having any size and refractive index is applied to a plurality of kinds of optically transparent binders; and (a-2) determining, based on the calculated results, an optically transparent binder consisting of a material optimized for lights from said at least two light sources.

In the present invention, the step (b) preferably comprises the sub-steps of: (b-1) calculating scattering characteristics for each of the wavelengths of lights from said at least two light sources on the basis of the light sources and the determined refractive index of the optically transparent binder; and (b-2) determining, from the calculated results, the optimized refractive index of the spherical dielectric particles.

In the present invention, the plurality of spherical dielectric particles in the step (c) is preferably either determined so as to have an optimized single size corresponding to lights from at least two light sources, or is determined so as to have sizes divided into at least two groups corresponding to the number of light sources.

In the present invention, the concentration ratio of each of the two groups of spherical dielectric particles is specified, the concentration ratio being preferably determined such that the total sum of scattering efficiencies for lights having different wavelengths are maintained at a constant value.

In another embodiment of the present invention, said at least two light sources consist of three light sources of red, green and blue LED light sources, which have wavelengths of 0.617 μm, 0.533 μm and 0.452 μm, respectively.

In the present invention, the optically transparent binder is preferably made of any one selected from among polymers, including polymethyl methacrylate (PMMA), polystyrene, polyurethane, benzoguanamine resin, and silicone resin.

In the present invention, the refractive index ratio between the optically transparent binder and the spherical dielectric particles is preferably in the range of 0.9<n_{particle}/n_{binder}<1.1(n_{particle}/n_{binder}≠1), wherein n_{particle} is the refractive index of the spherical dielectric particles, and n_{binder} is the refractive index of the optically transparent binder.

In the present invention, the plurality of spherical dielectric particles is preferably made of any one selected from among inorganic materials, including silica, talc, zirconium, zinc oxide, and titanium dioxide.

In the present invention, the optimized radial size of the spherical dielectric particles in the optically transparent binder is preferably in the range of 0.1 μm to 8 μm.

In the present invention, the plurality of spherical dielectric particles in the step (c) is preferably determined so as to have sizes divided into three groups corresponding to three light sources, the three groups of spherical dielectric particles having radii of r₁=2.95 μm, r₂=3.93 μm, and r₃=5.01 μm, respectively.

In the present invention, the three groups of spherical dielectric particles are constructed so as to have a concentration ratio of N₁:N₂:N₃=0.62:0:0.38, wherein N₁, N₂ and N₃ represent the concentrations of particles having radii of r₁, r₂ and r₃, respectively.

According to another embodiment of the present invention, there is provided a front scattering film having no wavelength dependency, which is the above-described manufacturing method. As used herein, the phrase “having no wavelength dependency” means that, when white light is formed by a plurality of light sources, the efficiency thereof is maintained uniform regardless of differences in wavelength between the light sources.

### BRIEF DESCRIPTION OF THE DRAWINGS

The above and other objects, features and advantages of the present invention will be more clearly understood from the following detailed description taken in conjunction with the accompanying drawings, in which:

FIG. 1 shows an isotropic light-scattering film according to the prior art;

FIG. 2 shows a front scattering film according to one embodiment of the present invention;

FIGS. 3A to 3F are graphic diagrams showing front and backward scattering efficiencies for each of light sources in the case where polymethyl methacrylate (PMMA) is used as an optically transparent binder;

FIGS. 4A to 4F are graphic diagrams showing front and backward scattering efficiencies for each of light sources in the case where polycarbonate (P-carb) is used as an optically transparent binder;

FIGS. 5A and 5B are graphic diagrams showing angular scattering intensities according to changes in the refractive indexes of spherical dielectric particles dispersed in polymethyl methacrylate (PMMA);

FIG. 6 is a graphic diagram showing scattering efficiency according to the size of spherical dielectric particles dispersed in an optically transparent binder; and

FIG. 7 is a graphic diagram showing an example of extracting the optimized single size of spherical dielectric particles from the graph of FIG. 6.

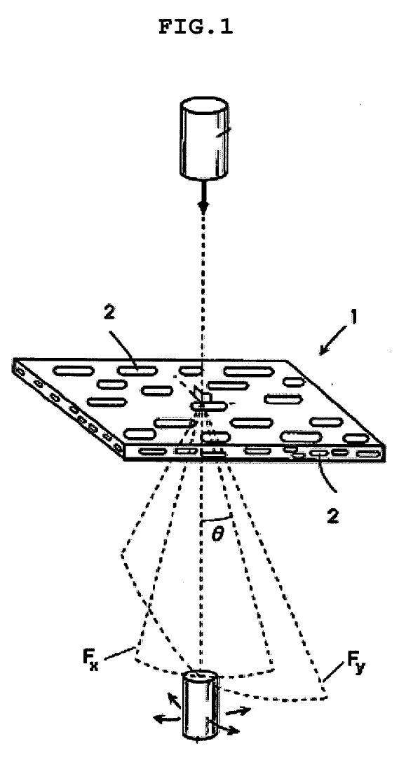

### DETAILED DESCRIPTION OF THE INVENTION

Hereinafter, preferred embodiments of the present invention will be described in detail with reference to the accompanying drawings.

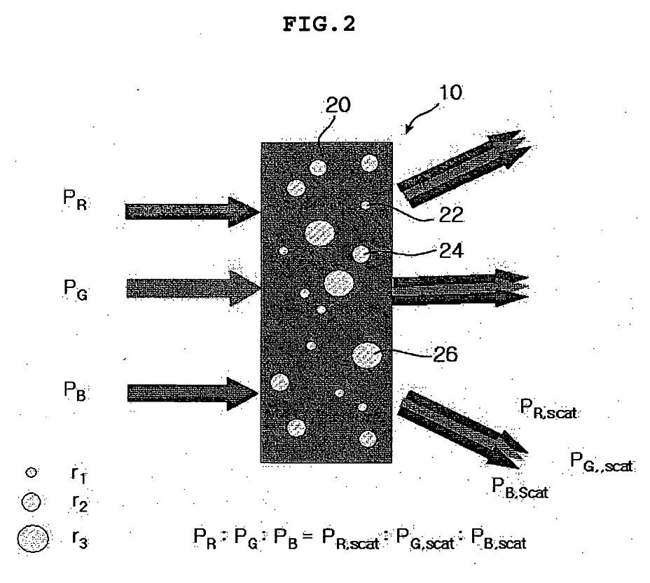

FIG. 2 shows a front scattering film according to one embodiment of the present invention. Referring to FIG. 2, a front scattering film 10 according to the present invention comprises an optically transparent binder 20 and a plurality of spherical dielectric particles 22, 24 and 26 dispersed in the optically transparent binder. In this embodiment, the front scattering film according to the present invention is characterized in that it receives lights from three-color light sources of red, green and blue and has scattering characteristics for each of these lights.

Although the construction of the front scattering film is disclosed on the basis of the three-color light sources (red, green and blue LED light sources) in this embodiment, it is of note that the scope of the present invention is not limited thereto, and the present invention is applicable to a combination of two or more light sources (for example, green and blue light sources or six-color light sources) capable of producing white light Hereinafter, the present invention will be described on the basis of three-color light sources for the convenience of description.

To provide this front scattering film, the optically transparent binder and the characteristics of the spherical dielectric particles that are contained in the binder must be determined.

For example, a plurality of spherical dielectric particles 22, 24 and 26 divided into three sizes (expressed as, for example, particle radii, r₁, r₂ and r₃ in this embodiment) corresponding to three-color light sources is distributed and formed in the optically transparent binder 20 so as to have a specific concentration ratio (N₁:N₂:N₃). Herein, N₁ represents the concentration of the spherical dielectric particle group expressed as radius r₁ in the optically transparent binder, N₂ represents the concentration of the spherical dielectric particle group expressed as radius r₂ in the optically transparent binder, and N₃ represents the concentration of the spherical dielectric particle group expressed as radius r₃ in the optically transparent binder.

Specific conditions, including the refractive index ratio between the optically transparent binder and the spherical dielectric particles, the sizes of the spherical dielectric particles and the concentration ratio between the spherical dielectric particles having different sizes, can be assured such that lights from, for example, three light sources (red, green and blue LED light sources, expressed as P_{R}, P_{G} and P_{B}, respectively) having different wavelengths, are scattered at the same ratio as the incident ratio in all directions while passing through the front scattering film 10.

In other words, as shown in FIG. 2, the sizes (r₁, r₂ and r₃) of the spherical dielectric particles are determined so as to satisfy P_{R}:P_{G}:P_{B}=P_{R,scat}:P_{G,scat}:P_{B,scat}, and the concentration ratio (N₁:N₂:N₃) between these spherical dielectric particles dispersed in the optically transparent binder can be suitably determined. Herein, P_{R,scat} represents the case where light from the red LED light source is scattered, P_{G,scat} represents the case where light from the green LED light source is scattered, and P_{B,scat} represents the case where light from the blue LED light source is scattered.

As a result, the front scattering film according to the embodiment of the present invention can reflect white light that has uniform luminance and brightness on the entire surface of the screen of a backlight unit by receiving lights from the three-color LED light sources of red, green and blue, and has uniform scattering characteristics for each of the lights.

Hereinafter, the results of simulations conducted while changing conditions of the refractive index ratio between the optically transparent binder and the spherical dielectric particles, the sizes of the particles, and the like, will be presented. Such simulations can be realized through numerical analysis (NA) methods using known equations regarding light-scattering technology, called Mie theory. Scattering characteristics, i.e., scattering intensity (I) and scattering efficiency (Q), which correspond to each case, can be calculated by providing input values provided as range values for each case. Herein, the scattering characteristics can be calculated using the Mie theory, represented by the above-described Equation 1 and Equation 2. On the basis of the calculated values, steps of determining the conditions corresponding to the object of the present invention can be carried out.

Specifically, to calculate scattering characteristics for each case, the following conditions were set.

First, as the optically transparent binders, polymer-based resins were used. In this embodiment, polymethyl methacrylate (PMMA) and polycarbonate (P-Carb), having relatively low refractive indexes, were used. It is of note that the refractive indexes of polymethyl methacrylate (PMMA) were simulated to be 1.4906 at a light source wavelength of 0.617 μm, 1.4947 at a light source wavelength of 0.533 μm, and 1.501 at a light source wavelength of 0.452 μm, in view of the dispersion of light. Also, the refractive indexes of polycarbonate (P-Carb) were simulated to be 1.583 at a light source wavelength of 0.617 μm, 1.5921 at a light source wavelength of 0.533 μm, and 1.6075 at a light source wavelength of 0.452 μm.

Then, the wavelength of light from the red LED light source was calculated to be 0.617 μm, the wavelength of light from the green LED light source was 0.533 μm, and the wavelength of light from the blue LED light source was 0.452 μm.

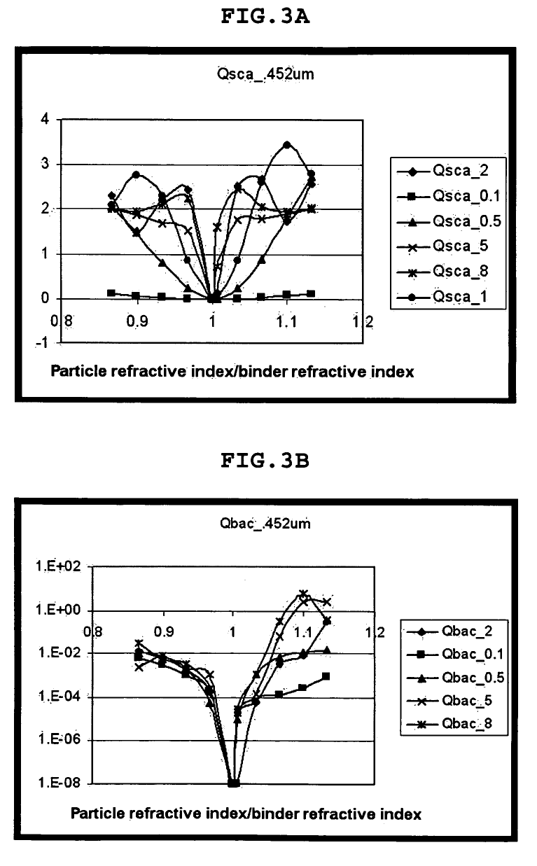

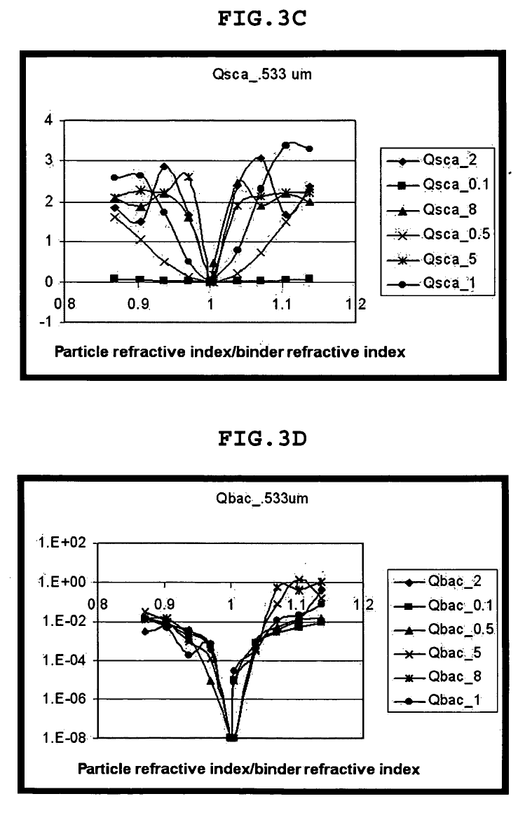

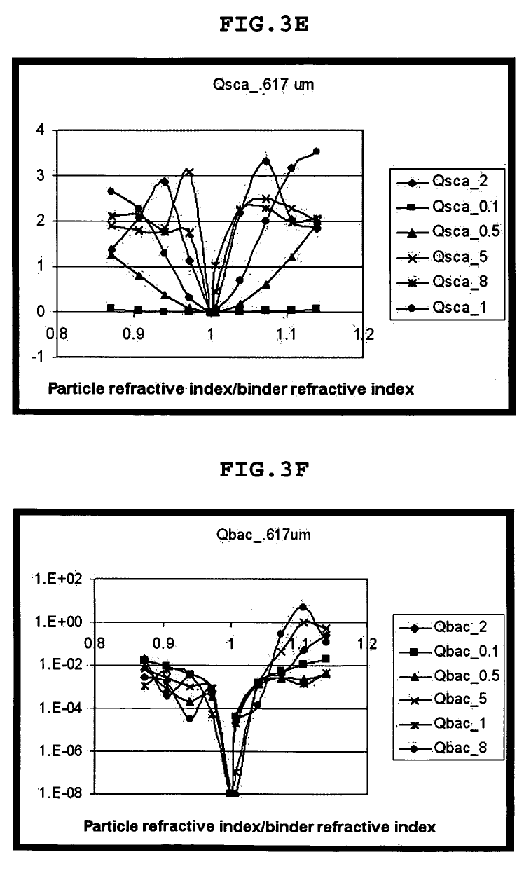

In such conditions, front and backward scattering efficiencies for varying light sources (wavelengths) were simulated while changing the sizes of the spherical dielectric particles and locating the ratio of the refractive index of the particles to the refractive index of the optically transparent binder within the range of 0.8-1.2, in a state where polymethyl methacrylate (PMMA) was used as the optically transparent binder. The simulation results are shown in FIGS. 3A to 3F.

FIGS. 3A and 3B show scattering efficiencies for the blue LED light source (0.452 μm), FIGS. 3C and 3D show scattering efficiencies for the green LED light source (0.533 μm), and FIGS. 3E and 3F show scattering efficiencies for the red LED light source (0.617 μm). Notes (Qsca_{—}0.1, Qsca_{—}0.5, Qsca_{—}1, Qsca_{—}2, Qsca_{—}5 and Qsca_{—}8) on the right side of the graphs in the drawings indicate front scattering efficiencies for spherical dielectric particle sizes of 0.1 μm, 0.5 μm, 1 μm, 2 μm, 5 μm and 8 μm, respectively. Also, notes (Qbac_{—}0.1, Qbac_{—}0.5, Qbac_{—}1, Qbac_{—}2, Qbac_{—}5 and Qbac_{—}8) on the left side of the graphs in the drawings indicate backward scattering efficiencies for spherical dielectric particle sizes of 0.1 μm, 0.5 μm, 1 μm, 2 μm, 5 μm and 8 μm.

As can be seen in FIGS. 3A to 3F, the scattering efficiencies of the film were observed to be high when the refractive index ratio between the spherical dielectric particles and the optically transparent binder (particle refractive index/binder refractive index or n_{particle}/n_{binder}) was in the range of 0.9-1.1 (except for 1) (see FIGS. 3A to 3F), and the efficiencies of scattering toward the front of the scattering film (see FIGS. 3A, 3C and 3E) were significantly higher than the efficiencies of scattering toward the back of the film (see FIGS. 3B, 3D and 3F). For example, when the efficiency of scattering toward the front of the film had a value of about 2-3, the efficiency of scattering toward the back of the film had a value from 1/100 to 1/10000, suggesting that the scattering characteristics at the back of the film were sufficiently reduced.

Thus, through the results of FIG. 3A to 3F, it can be determined that it is preferable that the ratio of the spherical dielectric particles and the optically transparent binder (n_{particle}/n_{binder}) in the front scattering film of the present invention be adjusted in the range of 0.9-1.1 (except for 1).

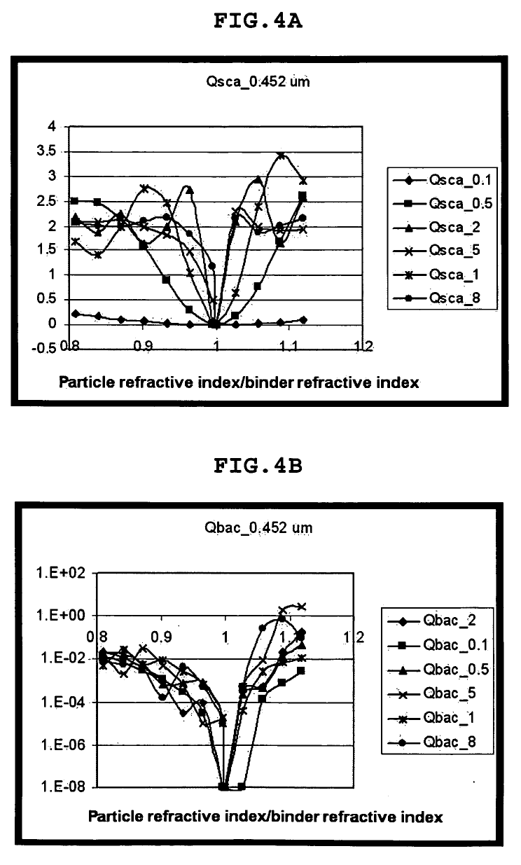

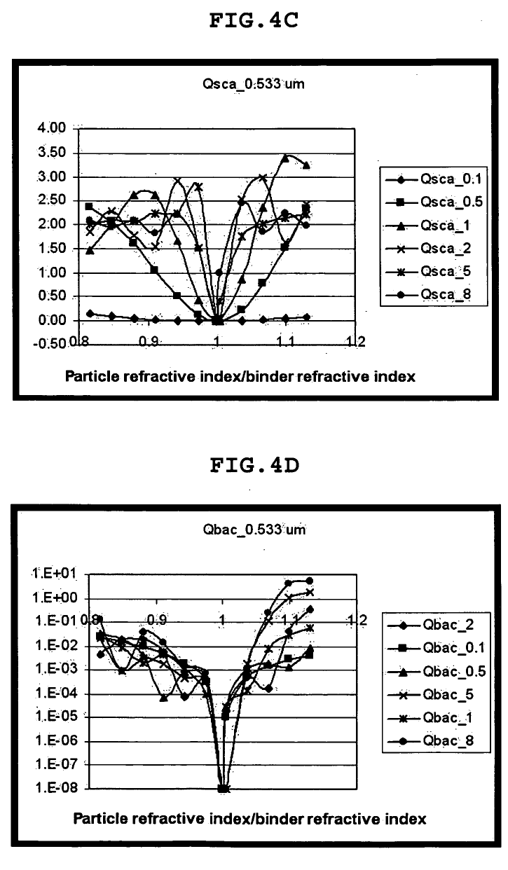

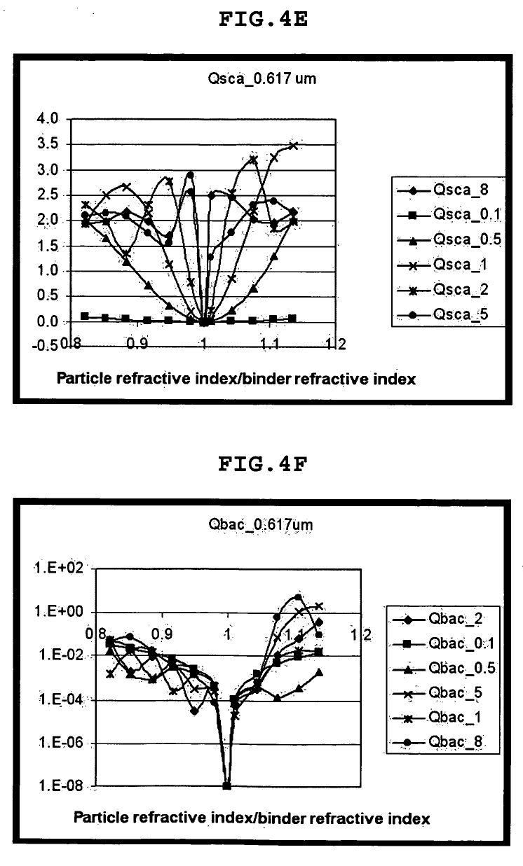

Then, in the above-described conditions, front and backward scattering efficiencies for varying light sources (wavelengths) were simulated while changing the sizes of the spherical dielectric particles and locating the ratio of the refractive index of the particles to the refractive index of the optically transparent binder within the range of 0.8-1.2, in a state where polycarbonate (P-Carb) was used as the optically transparent binder. The simulation results are shown in FIGS. 4A to 4F.

The simulations having the results of FIGS. 4A to 4F were carried out in conditions substantially similar to the simulations having the results of FIGS. 3A to 3F, except that the material of the optically transparent binder was changed from polymethyl methacrylate to polycarbonate. Thus, a detailed description thereof will be omitted.

FIGS. 4A and 4B show scattering efficiencies for the blue LED light source (0.452 μm), FIGS. 4c and 4d show scattering efficiencies for the green LED light source (0.533 μm), and FIGS. 4E and 4F show scattering efficiencies for the red LED light source (0.617 μm).

As can be seen in FIGS. 4A to 4F, the light scattering efficiencies of the film were shown to be high when the refractive index ratio between the spherical dielectric particles and the optically transparent binder (particle refractive index/binder refractive index or n_{particle}/n_{binder}) was in the range of 0.9-1.1 (except for 1) (see FIGS. 4A to 4F), and the efficiencies of scattering toward the front of the scattering film (see FIGS. 4A, 4C and 4E) were significantly higher than the efficiencies of scattering toward the back of the film (see FIGS. 4B, 4D and 4F). For example, when the efficiency of scattering toward the front of the film had a value of about 1.5-2.5, the efficiency of scattering toward the back of the film had a value from 1/10 to 1/1000, suggesting that scattering characteristics at the back of the film were sufficiently reduced.

Thus, through the results of FIG. 4A to 4F, it can be found that it is preferable that the ratio of the spherical dielectric particles and the optically transparent binder (n_{particle}/n_{binder}) in the front scattering film of the present invention be adjusted so as to fall within the range of 0.9-1.1 (except for 1).

The step of calculating scattering characteristics for polymethyl methacrylate (PMMA) and polycarbonate (PC) as the optically transparent binders, diagramming the calculated values, and then determining, based on the diagrams, the optimal ratio of the refractive index of the optically transparent binder to the refractive index of the spherical dielectric particles, etc., were described above. It is evident that the kind of optically transparent binder (i.e., the refractive index of the optically transparent binder) resulting in optimized scattering characteristics be determined by repeatedly carrying out this step. For reference, subsequent steps will now be described on the basis of polymethyl methacrylate for the convenience of description.

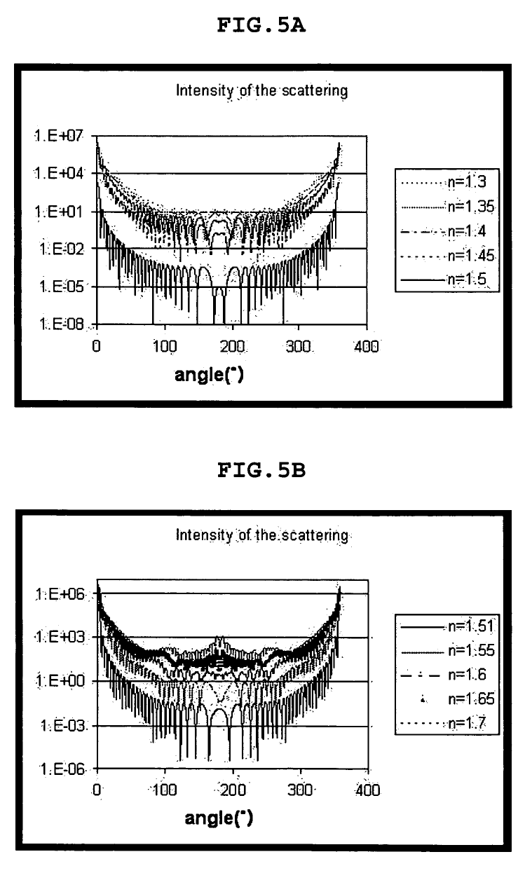

Then, FIGS. 5A and 5B are graphic diagrams showing scattering intensities (I) for the wavelength (0.452 μm) of the blue LED light source according to changes in the refractive index of the spherical dielectric particles fixed at a radius of 2 μm, when polymethyl methacrylate (PMMA) is used as the optically transparent binder.

As shown in notes on the left side of the graphs in FIGS. 5A and 5B, the refractive index of the spherical dielectric particles is optionally selected in the range of 1.3-1.7, and the scattering intensity for each refractive index is shown at varying angles (0°-360°).

For example, FIG. 5A shows the case where the ratio of the refractive index of the spherical dielectric particles to the refractive index of the optically transparent binder (n_{particle}/n_{binder}) is greater than 0.9, but smaller than 1, and FIG. 5B shows the case where the ratio of the refractive index of the spherical dielectric particles to the refractive index of the optically transparent binder (n_{particle}/n_{binder}) is greater than 1, but smaller than 1.1.

From FIGS. 5A and 5B, it can be found that the peak scattering intensity is shown at about 10° in the front direction.

As can be seen in the above graphs (FIGS. 3 to 5), scattering efficiencies simulated for at least two light sources having different wavelengths are different depending on wavelengths, the sizes of the spherical dielectric particles, and the refractive indexes of the spherical dielectric particles. Also, it can be seen that, even in the case of spherical dielectric particles having the same refractive index, the scattering efficiencies thereof are different depending on the sizes thereof.

Determining optimized conditions for the spherical dielectric particles using such results can be performed as follows.

For examples, the total sum of scattering efficiencies, represented by Equation 6 below, can be expressed using, as parameters, spherical dielectric particles having different sizes (r1, r2, r3) for three-color light sources (R, G and B) and substituting the determined refractive index of the optically transparent binder and the spherical dielectric particles having a specific refractive index ratio thereto, as constants, into the parameters.
Sum=Qᵣ(r₁)+Q_{g}(r₁)+Q_{b}(r₁)+Qᵣ(r₂)+Q_{g}(r₂)+Q_{b}(r₂)+Qᵣ(r₃)+Q_{g}(r₃)+Q_{b}(r₃) [Equation]
wherein Qᵣ represents a scattering efficiency value for the red LED light source, Q_{g} represents a scattering efficiency value for the green LED light source, and Q_{b} represents a scattering efficiency value for the blue LED light source.

Scattering efficiencies that are distinguished depending on the light sources and the sizes of the spherical dielectric particles can be expressed in the form of matrices according to Equation 7 below.
Q(blue)=Q_{b}(r₁)/Sum Q(green)=Q_{g}(r₁)/Sum Q(red)=Qᵣ(r₁)/Sum
Q(blue)=Q_{b}(r₂)/Sum Q(green)=Q_{g}(r₂)/Sum Q(red)=Qᵣ(r₂)/Sum
Q(blue)=Q_{b}(r₃)/Sum Q(green)=Q_{g}(r₃)/Sum Q(red)=Qᵣ(r₃)/Sum [Equation 7]
wherein Q₁(blue), Q₁(green) and Q₁(red) represent scattering efficiency values for blue LED, green LED and red LED light sources, respectively, at a spherical dielectric particle size of radius r₁, Q₂(blue), Q₂(blue), Q₂(green) and Q₂(red) represent scattering efficiency values for blue LED, green LED and red LED light sources, respectively, at a spherical dielectric particle size of radius r₂, and Q₃(blue), Q₃(green) and Q₃(red) represent scattering efficiency values for blue LED, green LED and red LED light sources, respectively, at a spherical dielectric particle size of radius r₃.

Equation 8 can be expressed as the sum of scattering efficiencies for each light source according to Equations 8 and 9 below.
Q_{eff}(blue)=N₁Q₁(blue)+N₂Q₂(blue)+N₃Q₃(blue)
Q_{eff}(green)=N₁Q₁(green)+N₂Q₂(green)+N₃Q₃(green)
Q_{eff}(red)=N₁Q₁(red)+N₂Q₂(red)+N₃Q₃(red) [Equation 8]
Q_{eff}(blue)=Q_{eff}(green)=Q_{eff}(red) [Equation 9]
wherein each of N₁, N₂ and N₃ can be expressed as the number (concentration ratio) of spherical dielectric particles having radii of r₁, r₂ and r₃ dispersed in the optically transparent binder, Q_{eff}(blue) represents the scattering efficiency of the blue LED light source, based on the total amount of dielectric particles (Q₁, Q₂ and Q₃), Q_{eff}(green) represents the scattering efficiency of the green LED light source, based on the total amount of dielectric particles (Q₁, Q₂ and Q₃), and Q_{eff}(red) represents the scattering efficiency of the red LED light source, based on the total amount of dielectric particles (Q₁, Q₂ and Q₃).

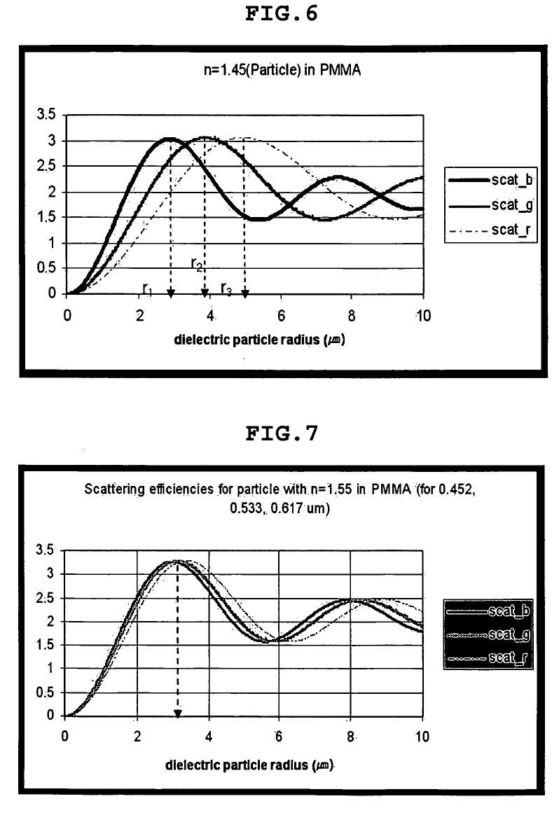

Such scattering efficiencies can be calculated based on the above-described Mie theory. Thus, the optimized concentration ratio between the spherical dielectric particles can be found by substituting the scattering efficiencies found in Equation 8 into Equation 9 and solving Equation 9 under a restricted condition of (N₁, N₂, N₃)≧0. The details of this process will now be described with reference to FIG. 6.

The size of particles and scattering efficiency value for each of light sources, obtained based on such Equations, are shown in FIG. 6. For example, FIG. 6 is a graphic diagram showing scattering efficiencies according to changes in the size (radius) of the spherical dielectric particles for light from each of the LED light sources, in the case where polymethyl methacrylate (PMMA) is used as the optically transparent binder and the refractive index of the spherical dielectric particles is fixed at 1.45. As can be seen in FIG. 6, the highest scattering efficiency values appear at points indicated by r₁, r₂ and r₃ for each of the light sources in the above conditions, and this can be expressed in the equation Q_{f}(λ₁)=Q_{f}(λ₂)=Q_{f}(λ₃).

Thus, the sizes of the dielectric particles corresponding to the cases having uniform scattering efficiency values (Q_{f}(λ₁), Q_{f}(λ₂), Q_{f}(λ₃) for each wavelength can be found as shown by the arrows in FIG. 6. The sizes of the particles, found in FIG. 6, are approximately r₁=2.95 μm, r₂=3.93 μm and r₃=5.01 μm.

As described above, the concentration ratio between the spherical dielectric particles having the specified sizes (r₁, r₂ and r₃), dispersed in the optically transparent binder, can be found using Equations 8 and 9 above.

Thus, the optimized concentration ratio between the particles can be finally determined by substituting scattering efficiencies, found using Equation 8, into Equation 9 and solving Equation 9 under a restricted condition of (N₁, N₂, N₃)≧0. As a result, the concentration ratio between the spherical dielectric particles having sizes of r₁=2.95 μm, r₂=3.93 μm and r₃=5.01 μm is N₁:N₂:N₃=0.62:0:0.38.

Meanwhile, FIG. 7 shows that particles are not optimized as a plurality of sizes corresponding to the wavelengths of light sources on the basis of scattering efficiencies obtained through the same step, as in FIG. 6, but rather that particles having a single size are applied to the wavelength of each light source, and scattering efficiency for each light source can be optimized as an approximate value due to the applied particle size.

In other words, as shown in FIG. 6, a plurality of particle sizes optimized for all the light sources is not set, but, as shown in FIG. 7, the case of setting single particle size approximately optimized for all light sources can be considered, and it can be constructed more effectively than causing the plurality of spherical dielectric particles dispersed in the optically transparent binder to have a plurality of sizes.

As described above, in the front scattering film and the manufacturing method thereof according to the present invention, the plurality of spherical dielectric particles formed to have a plurality of sizes corresponding to at least two light sources is dispersed in the optically transparent polymer binder at a specific particle concentration ratio, and thus, when lights from a plurality of light sources are mixed in the binder and reflected as white light, the inventive front scattering film can provide uniform scattering characteristics for each of the wavelengths of the light sources. Alternatively, spherical dielectric particles having a single size, approximately corresponding to each light source, can also be constructed.

Although two kinds of optically transparent bonders, including polymethyl methacrylate and polycarbonate, are suggested in the embodiment of the present invention, it is of note that the scope of the present invention is not limited thereto, and that the optically transparent binder can consist of any one selected from among polymers, including polyurethane, benzoguanamine resin, and silicone resin.

Also, the spherical dielectric particles in the present invention can consist of any one selected from inorganic materials, including silica, talc, zirconium, zinc oxide, and titanium dioxide.

In addition, it is of note that, when the kinds of optically transparent binder and the spherical dielectric particles dispersed therein are changed, the suitable size ratio (e.g., the ratio of a plurality of sizes divided into r₁, r₂ and r₃) and concentration ratio (e.g., the ratio of a plurality of concentrations divided into N₁, N₂ and N₃) should be applied through the above-described steps.

As described above, in the manufacturing method of the front scattering film according to the present invention, the plurality of spherical dielectric particles formed to have a plurality of sizes corresponding to a plurality of light sources is dispersed in the optically transparent polymer binder at a specific concentration ratio, and thus, when lights from a plurality of light sources are mixed in the binder and reflected as white light, the inventive front scattering film can provide uniform scattering characteristics for each of the wavelengths of the light sources. Accordingly, the front scattering film can be provided which can reflect uniform white light effectively corresponding to a backlight unit system including a plurality of light sources (e.g., three-color light sources of red, green and blue) having different wavelengths.

Although the preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method for manufacturing a scattering film for backlight units, which comprises an optically transparent binder having a plurality of spherical dielectric particles dispersed therein, receives lights from at least two light sources having different wavelengths, and reflects white light, the method comprising the steps of:
(a) determining the optically transparent binder;
(b) determining the refractive indexes of a plurality of spherical dielectric particles on the basis of said at least two light sources and the determined optically transparent binder; and
(c) determining the sizes of the spherical dielectric particles and the concentration ratio between the spherical dielectric particles on the basis of the light sources, the determined optically transparent binder and the determined refractive indexes of the spherical dielectric particles;
wherein each of the steps (a) to (c) is carried out based on scattering characteristics expressed as scattering intensity (I) and scattering efficiency (Q), which are calculated using a numerical analysis method based on Mie theory, the scattering characteristics in a front direction with respect to a direction of light incident to the scattering film are significantly greater than the scattering characteristics in the backward direction, and the scattering characteristics for lights from said at least two light sources having different wavelengths are maintained uniform.

2. The method of claim 1, wherein the scattering intensity (I) is defined by Equation 1 below, and the scattering efficiency is defined by Equation 2:
$$\begin{matrix}I ( α , m , θ ) = \frac{{λ}^{2} ( {i}_{1} + {i}_{2} )}{8 {π}^{2}} & [ Equation 1 ] \\ Q ( α , m ) = \frac{{λ}^{2}}{2 {π}^{2} {r}^{2}} \cdot {\sum }_{v = 1}^{α} ( 2 v + 1 ) ( {\vert {a}_{v} \vert}^{2} + {\vert {b}_{v} \vert}^{2} ) & [ Equation 2 ]\end{matrix}$$
wherein α is a size parameter represented by Equation 3:
$$α = \frac{2 \cdot π \cdot r \cdot {n}_{m}}{{λ}_{0}} \qquad [ Equation 3 ]$$
wherein r is the radius of spherical dielectric particles, λ is the wavelength of light, m is the ratio between the refractive index (nₛ) of the spherical dielectric particles and (nₛ) and the refractive index (nₘ) of the matrix-type optically transparent binder (nₘ), each of i₁ and i₂ is represented by Equation 4, and each of a_{υ} and b_{υ} is represented by Equation 5:
$$\begin{matrix}{i}_{1} = {\vert {\sum }_{v = 1}^{∞} \frac{( 2 v + 1 )}{v ( v + 1 )} \cdot [ \begin{matrix}{a}_{v} \cdot \frac{{P}_{v}^{1} ( cos ( θ ) )}{sin ( θ )} + \\ {b}_{v} \cdot \frac{ⅆ {P}_{v}^{1} ( cos ( θ ) )}{ⅆ θ}\end{matrix} ] \vert}^{2} \\ {i}_{2} = {\vert {\sum }_{v = 1}^{∞} \frac{( 2 v + 1 )}{v ( v + 1 )} \cdot [ \begin{matrix}{b}_{v} \cdot \frac{{P}_{v}^{1} ( cos ( θ ) )}{sin ( θ )} + \\ {a}_{v} \cdot \frac{ⅆ {P}_{v}^{1} ( cos ( θ ) )}{ⅆ θ}\end{matrix} ] \vert}^{2} & [ Equation 4 ] \\ {a}_{v} = \frac{{ψ}_{v}^{′} ( m α ) \cdot {ψ}_{v} ( α ) - m {ψ}_{v} ( m α ) \cdot {ψ}_{v}^{′} ( α )}{{ψ}_{v}^{′} ( m α ) \cdot {}_{v} ( α ) - m {ψ}_{v} ( m α ) \cdot {}_{v}^{′} ( α )} \\ {b}_{v} = \frac{m \cdot {ψ}_{v}^{′} ( m α ) \cdot {ψ}_{v} ( α ) - {ψ}_{v} ( m α ) \cdot {ψ}_{v}^{′} ( α )}{m \cdot {ψ}_{v}^{′} ( m α ) \cdot {}_{v} ( α ) - {ψ}_{v} ( m α ) \cdot {}_{v}^{′} ( α )} & [ Equation 5 ]\end{matrix}$$
wherein ψ and ζ are Riccarti-Bessel functions.

3. The method of claim 1, wherein the step (a) comprises sub-steps of:
(a-1) calculating scattering characteristic for each of cases where a plurality of spherical dielectric particles having any size and refractive index is applied to a plurality of kinds of optically transparent binders; and
(a-2) determining, based on the calculated results, an optically transparent binder consisting of a material optimized for lights from said at least two light sources.

4. The method of claim 3, wherein the step (b) comprises sub-steps of:
(b-1) calculating scattering characteristics for each of the wavelengths of lights from said at least two light sources on the basis of the light sources and the determined refractive index of the optically transparent binder; and
(b-2) determining, based on the calculated results, the optimized refractive index of the spherical dielectric particles.

5. The method of claim 4, wherein, in the step (c), the plurality of spherical dielectric particles is determined so as to have an optimized single size corresponding to lights from at least two light sources.

6. The method of claim 4, wherein, in the step (c), the plurality of spherical dielectric particles is determined so as to have sizes divided into at least two groups corresponding to the plurality of light sources.

7. The method of claim 6, wherein the concentration ratio between the two groups of spherical dielectric particles is specified, the concentration ratio being determined such that the total sum of scattering efficiencies for lights having different wavelengths are maintained at a constant value.

8. The method of claim 1, wherein said at least two light sources are three light sources of red, green and blue LED light sources, which have wavelengths of 0.617 μm, 0.533 μm and 0.452 μm, respectively.

9. The method of claim 8, wherein the step (a) comprises the sub-steps of:
(a-1) calculating scattering characteristic for each of the cases where a plurality of spherical dielectric particles having any size and refractive index is applied to a plurality of kinds of optically transparent binders; and
(a-2) determining, based on the calculated results, an optically transparent binder consisting of a material optimized for lights from said at least two light sources;
wherein the optically transparent binder consists of any one selected from among polymers, including polymethyl methacrylate (PMMA), polystyrene, polyurethane, benzoguanamine resin, and silicone resin.

10. The method of claim 9, wherein the step (b) comprises sub-steps of:
(b-1) calculating scattering characteristics for each of the wavelengths of lights from said at least two light sources on the basis of the light sources and the determined refractive index of the optically transparent binder; and
(b-2) determining, based on the calculated results, the optimized refractive index of the spherical dielectric particles;
wherein the refractive index ratio between the optically transparent binder and the spherical dielectric particles is in the range of 0.9< n_{particle}/n_{binder}<1.1 (n_{particle}/n_{binder}≠1), wherein n_{particle} is the refractive index of the spherical dielectric particles, and n_{binder} is the refractive index of the optically transparent binder.

11. The method of claim 10, wherein the plurality of spherical dielectric particles is made of any one selected from among inorganic materials, including silica, talc, zirconium, zinc oxide, and titanium dioxide.

12. The method of claim 11, wherein the optimized radial size of the spherical dielectric particles in the optically transparent binder is in the range of 0.1 μm to 8 μm.

13. The method of claim 12, wherein, in the step (c), the plurality of spherical dielectric particles is constructed so as to have sizes divided into three groups corresponding to three light sources, the three groups of spherical dielectric particles having radii of r₁=2.95 μm, r₂=3.93 μm, and r₃=5.01 μm, respectively.

14. The method of claim 13, wherein, in the step (c), the three groups of spherical dielectric particles are constructed so as to have a concentration ratio of N₁:N₂:N₃=0.62:0:0.38, wherein N₁, N₂ and N₃ denote the concentrations of particles having radii of r₁, r₂ and r₃, respectively.

15. A front scattering film having no wavelength dependency, which is manufactured according to the method of claim 1.
